(19) United States
(12) Patent Application Publication
(10) Pub. No.: US 2006/0068661 A1
(43) Pub. Date: Mar. 30, 2006

(54) Wiping products having a high equilibrium moisture and a low coefficient of friction

(75) Inventor: Thomas Gerard Shannon, Neenah, WI (US)

Correspondence Address: KIMBERLY-CLARK WORLDWIDE, INC., 401 NORTH LAKE STREET, NEENAH, WI, 54956, US

(73) Assignee: Kimberly-Clark Worldwide, Inc.

(21) Appl. No.: 10/955,533

(22) Filed: Sep. 29, 2004

(51) Int. Cl. B32B 33/00; B32B 21/02; B32B 29/06

(52) U.S. Cl. 442/102; 442/97; 442/118; 442/119; 442/153

(57) ABSTRACT

The surface feel of wiping products, such as facial tissues, bath tissues and paper towels, can be improved by incorporating into the product a deliquescent material and a friction reduction compound. The deliquescent material maintains a very high equilibrium amount of water in the product, which in turn effectively enables the friction reduction compound to enhance the smooth surface feel of the product.

### BACKGROUND OF THE INVENTION

Tissue products that have a low coefficient of friction are often viewed by the consumer as being softer than tissue products with a high coefficient of friction. In response, tissue manufacturers have employed mechanical and chemical means to reduce the coefficient of friction in tissue products. In particular, mechanical methods include heavily calendering the tissue sheet to smoothen the surface, but calendering also reduces the bulk of the sheet, which is most often undesirable. Chemical methods particularly include the topical addition of polysiloxanes to the tissue sheet, which is very effective at reducing the coefficient of friction. The reduction in the coefficient of friction is believed to be largely due to the low surface energy of the polysiloxane. Only polyfluoroethylene compounds, such as Teflon®, have a lower free surface energy than polysiloxanes. Unfortunately, polysiloxanes are relatively expensive and thus their use in tissue products has been limited to premium products. Polyfluoroethylene compounds are even more expensive and are not practical. Also, polysiloxanes generally have a negative impact on the absorbency of the tissue sheets.

Therefore there is a need for a means to economically reduce the coefficient of friction of wiping products generally, specifically including tissue products, while maintaining their bulk and absorbency.

### SUMMARY OF THE INVENTION

It has now been discovered that a combination of deliquescent materials and certain friction reduction compounds synergistically provide a very low coefficient of friction in tissue sheets and hence improve the perception of softness by the user.

Hence, in one aspect the invention resides in a wiping product comprising a non-woven fibrous sheet containing a deliquescent material and a friction reduction compound.

As used herein, a “deliquescent material” is any material that is a solid material at room temperature when dry that can absorb a sufficient amount of moisture from the air to form a solution or any liquid material that can absorb greater than 50% by weight of water from the air to form a homogeneous aqueous solution. While any deliquescent material can be used for purposes of this invention, suitable deliquescent materials include certain inorganic salts such as aluminates, calcium chloride, lithium chloride, magnesium chloride, sodium acetate, potassium acetate and ammonium acetate and certain organic salts such as trimethylamine n-oxide.

The amount of deliquescent material in the sheets of the products of this invention can be any amount that provides the desired equilibrium moisture content. More specifically, the amount can be from about 1 to about 150 percent by weight of dry fiber or greater, more specifically from about 1 to about 125 dry weight percent, more specifically from about 1 to about 100 dry weight percent, more specifically from about 2 to about 75 dry weight percent, more specifically from about 2 to about 50 dry weight percent, more specifically from about 2 to about 25 dry weight percent, and still more specifically from about 2 to about 10 dry weight percent. The specific add-on amount of the deliquescent material is not critical as long as the desired equilibrium moisture content is achieved and will in part depend upon the specific deliquescent material selected. The deliquescent material can be incorporated into the wiping product by any suitable means, such as spraying or, if the sheet is made by a wet-laying process, incorporating the deliquescent material into the water used to suspend the fibers prior to sheet formation. Additionally, the deliquescent material can be added to the sheet as a neat liquid or a solid. The deliquescent material will then absorb moisture from the air and distribute throughout the sheet.

The “equilibrium moisture content” of the sheet can be about 8 dry weight percent or greater, more specifically about 10 dry weight percent or greater, more specifically from about 8 to about 200 dry weight percent, more specifically from about 10 to about 100 dry weight percent, more specifically from about 10 to about 50 dry weight percent and still more specifically from about 10 to about 30 dry weight percent. By comparison, cellulose sheets such as conventional tissues and towels typically have an equilibrium moisture content of about 5 percent. It has been found that the elevated moisture content afforded by the deliquescent material provides sufficient moisture to enable the friction reduction compound to have a noticeable effect to the user. An elevated equilibrium moisture content in a dry wiping product can give the feel of a slightly moist sheet, which in and of itself can be advantageous to the user. However, the equilibrium moisture content should not be so high that it conveys the feeling of a wet product if intended to be used as a dry wiping product. The equilibrium moisture content in the sheet can be controlled by the absorbent capacity of the sheet, the amount of water on a percent basis that the deliquescent material absorbs and the amount of deliquescent material in the sheet.

As used herein, a “friction reduction compound” is a material capable of reducing the coefficient of friction (COF) of a non-woven or cellulosic sheet when the non-woven or cellulosic sheet is wetted with water. Particularly useful friction reduction compounds include, without limitation, high molecular weight polyethylene oxide, derivatized polyethylene oxide, cationic acrylamide copolymers having a pendant ethylene oxide moiety, and mixtures thereof.

The amount of the friction reduction compound in the sheets of the products of this invention can be any amount that provides a decrease in the coefficient of friction of the sheet. More specifically, the amount can be about 0.001 weight percent or greater based on the weight of dry fiber, more specifically from about 0.005 to about 10 weight percent, more specifically from about 0.01 to about 5 weight percent and still more specifically from about 0.01 to about 1 weight percent. Typically, amounts greater than about 10 weight percent have a minimal impact on reducing the coefficient of friction.

The actual coefficient of friction values for the products of this invention will vary depending upon the particular basesheet that is used. Without limitation, typical static coefficient of friction values can be about 70 grams or less, more specifically about 65 grams or less, more specifically about 60 grams or less, and still more specifically from about 55 to about 70 grams. Typical kinetic coefficient of friction values can be about 80 grams or less, more specifically about 70 grams or less, more specifically about 65 grams or less, and still more specifically from about 60 to about 80 grams.

In one embodiment, the friction reduction compound is a high molecular weight polyethylene oxide. Polyethylene oxides useful for purposes of this invention have the following general formula:
R¹O—(CH₂CH₂O)ₙ R²
wherein R¹ and R² are hydrogen or organo-functional groups. R¹ and R² can be the same or different. These compounds have a weight average molecular weight of about 20,000 or greater, more specifically about 50,000 or greater. In one embodiment, the high molecular polyethylene oxide can have a molecular weight of from about 400,000 to about 2,000,000. As used herein, the molecular weight can be determined by conventional rheological measurements well known in the polymer art.

High molecular weight polyethylene oxides are available from various commercial sources. Examples of polyethylene oxide resins that can be used in the present invention are commercially available from the Union Carbide Corporation and are sold under the trade designations POLYOX N-205, POLYOX-N-750, POLYOX WSR N-10 and POLYOX WSR N-80. The above four products are believed to have weight average molecular weights of from about 100,000 to about 600,000 (g-mol). Polyethylene oxide resins may optionally contain various additives such as plasticizers, processing aids, rheology modifiers, antioxidants, UV light stabilizers, pigments, colorants, slip additives, antiblock agents, etc that may be incorporated in their manufacture.

When treating a sheet with a high molecular weight polyethylene oxide in accordance with the present invention, the high molecular weight polyethylene oxide, for most applications, is applied topically. In general, any suitable topical application process can be used to apply the composition. For example, in one embodiment, the polyethylene oxide can be combined with a solvent such as an alcohol or with water to form a solution and applied to the sheet. When applied as a solution, the composition can be sprayed or printed onto the sheet. Any suitable printing device, for instance, may be used. For example, an ink jet printer or a rotogravure printing machine may be used. When applied as a solution, the polyethylene oxide can be contained within the solution in an amount from about 0.05 percent to about 50 percent by weight. It should be understood, however, that more or less polyethylene oxide can be contained in the solution depending on the molecular weight of the polyethylene oxide and the type of application process that is used. In an alternative embodiment, a viscous aqueous or neat solution of the polyethylene oxide may be applied via a melt blowing or modified melt blowing technique. For example, the polyethylene oxide viscous aqueous solution may be extruded from a die head such as UFD spray tips, such as those available from ITW-Dynatec located in Henderson, Tenn. The polyethylene oxide or other friction reduction compound may also be applied simultaneously with the deliquescent compound.

In one embodiment, the high molecular weight polyethylene oxide can be heated prior to or during application to the sheet. Heating the composition can lower the viscosity to facilitate application. In one embodiment, the polyethylene oxide can be heated and extruded onto the sheet. Any suitable extrusion device can be used, such as a meltblown die. Extruding the composition containing the polyethylene oxide onto the sheet can provide some advantages in applications where the viscosity of the composition is relatively high. For instance, in one embodiment, the polyethylene oxide can be applied in a neat form when extruded onto the sheet.

When topically applied, the friction reduction compound containing polyethylene oxide can be applied to one side or to both sides of the sheet. Further, the composition can be applied to cover 100 percent of the surface area of the sheet or can be applied in a pattern that includes treated areas and untreated areas. For example, if applied in a pattern, the composition can cover from about 20 percent to about 99 percent of the surface area of one side of the sheet, such as from about 40 percent to about 90 percent of the surface area.

In general, the polyethylene oxide composition can be applied to the sheet at different points in the production of the wiping product. For example, if the wiping product is a paper product, such as a facial tissue, bath tissue, paper towel and the like, the polyethylene oxide composition can be applied while the sheet is still wet or after the sheet has been dried during formation. Alternatively, the polyethylene oxide composition can be applied after formation of the sheet during a converting operation.

In another embodiment the friction reduction compound can be a derivatized polyethylene oxide, particularly a derivatized high molecular weight polyethylene oxide. For example, polyethylene oxides as described above can be derivatized and used in this embodiment.

A derivatized polyethylene oxide may be formed by reacting a polyethylene oxide with one or more monomers to provide a functional group on the polyethylene oxide polymer. The derivative groups can be placed in the backbone of the polyethylene oxide or can be pendent groups. The derivative groups can be present in the polymer in an amount from about 0.5 percent to about 25 percent by weight, such as from about 0.5% to about 10% by weight.

In one embodiment, a derivatized polyethylene oxide for use in the present invention can be formed by grafting monomers onto the polyethylene oxide. The grafting is accomplished by mixing polyethylene oxide with one or more monomers and an initiator and applying heat. Such treated polyethylene oxide compositions are disclosed in U.S. Pat. No. 6,172,177 issued to Wang et al, which is incorporated herein by reference.

In this embodiment, a variety of polar vinyl monomers may be useful in the practice of the present invention. The term “monomer” as used herein includes monomers, oligomers, polymers, mixtures of monomers, oligomers, and/or polymers, and any other reactive chemical species which is capable of covalent bonding with polyethylene oxide. Ethylenically unsaturated polar vinyl monomers that may be used to derivatize a polyethylene oxide can include as a functional group hydroxyl, carboxyl, amino, carbonyl, halo, thiol, sulfonic, sulfonate, amine, amide, aldehyde, epoxy, silanol, azetidinium groups and the like.

In one embodiment, the unsaturated monomers include acrylates and methacrylates. Such monomers include 2-hydroxyethyl methacrylate (referred to as HEMA) and poly(ethylene glycol) methacrylate. For example, a poly(ethylene glycol) alkyl ether methacrylate can be used, such as poly(ethylene glycol) ethyl ether methacrylate or poly(ethylene glycol) methyl ether methacrylate.

When forming a derivatized polyethylene oxide in this embodiment, an initiator may be useful in forming the polymer. The initiator can generate free radicals when subjected to energy, such as the application of heat. Compounds containing an O—O, S—S, or N═N bond may be used as thermal initiators. Compounds containing O—O bonds; i.e., peroxides, are commonly used as initiators for graft polymerization. Such commonly used peroxide initiators include: alkyl, dialkyl, diaryl and arylalkyl peroxides such as cumyl peroxide, t-butyl peroxide, di-t-butyl peroxide, dicumyl peroxide, cumyl butyl peroxide, 1,1-di-t-butyl peroxy-3,5,5-trimethylcyclohexane, 2,5-dimethyl-2,5-di(t-butylperoxy)hexane, 2,5-dimethyl-2,5-bis(t-butylperoxy)hexyne-3 and bis(a-t-butyl peroxyisopropylbenzene); acyl peroxides such as acetyl peroxides and benzoyl peroxides; hydroperoxides such as cumyl hydroperoxide, t-butyl hydroperoxide, p-methane hydroperoxide, pinane hydroperoxide and cumene hydroperoxide; peresters or peroxyesters such as t-butyl peroxypivalate, t-butyl peroctoate, t-butyl perbenzoate, 2,5-dimethylhexyl-2,5-di(perbenzoate) and t-butyl di(perphthalate); alkylsulfonyl peroxides; dialkyl peroxymonocarbonates; dialkyl peroxydicarbonates; diperoxyketals; ketone peroxides such as cyclohexanone peroxide and methyl ethyl ketone peroxide. Additionally, azo compounds such as 2,2′-azobisisobutyronitrile (abbreviated as “AlBN”), 2,2′-azobis(2,4-dimethylpentanenitrile) and 1,1′-azobis(cyclohexanecarbonitrile) may be used as the initiator.

In one embodiment, the formation of a derivatized polyethylene oxide for use in the present invention can be illustrated as follows: 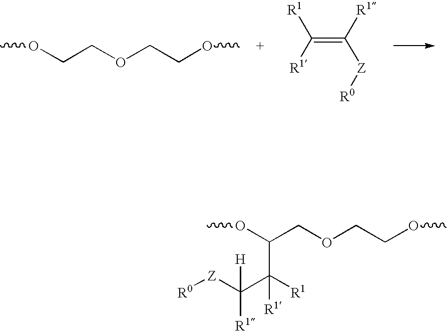
where R¹, R^{1′}, R^{1″}, are independently H or a C₁₋₄ alkyl, Z is any bridging radical whose purpose is to incorporate the R° moiety into the ethylenically unsaturated monomer, and R° is any group capable of forming covalent and/or hydrogen bonds with cellulose or with the polymer itself. Examples of suitable Z groups include but are not limited to —O—, —S—, —OOC—, —COO—, —HNOC—, —CONH. Suitable R⁰ functional groups include amine, amide, carboxyl, hydroxyl, aldehyde, epoxy, silanol, and azetidinium groups. The materials may incorporate a second ethylenically unsaturated monomer whose purpose is to provide a charge or basis for charge development within the polymer. The charge is preferably cationic but may be anionic or amphoteric. Incorporation of such charge now makes the material substantive to cellulose in a wet end application.

In one particular embodiment, the polyethylene oxide polymer is grafted with an amount of an organic moiety that includes a group that reacts with water to form a silanol group. For example, one such functional group that can react with water to form a silanol group is a trialkoxy silane functional group. The trialkoxy silane functional group can have the following structure: 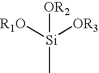
wherein R₁, R₂ and R₃ are the same or different alkyl groups, each independently having 1 to 6 carbon atoms.

In forming derivatized polyethylene oxides that contain a silanol group, the polyethylene oxide can be reacted with a monomer containing, for instance, a trialkoxy silane functional group as illustrated above. For example, in one embodiment, the monomer is an acrylate or methacrylate, such as methacryloxypropyl trimethoxy silane. Methacryloxypropyl propyl trimethoxy silane is commercially available from Dow Corning out of Midland, Mich. under the trade designation Z-6030 Silane.

Other suitable monomers containing a trialkoxy silane functional group include, but are not limited to, methacryloxyethyl trimethoxy silane, methacryloxypropyl triethoxy silane, methacryloxypropyl tripropoxy silane, acryloxypropylmethyl dimethoxy silane, 3-acryloxypropyl trimethoxy silane, 3-methacryloxypropylmethyl diethoxy silane, 3-methacryloxypropylmethyl dimethoxy silane, and 3-methacryloxypropyl tris(methoxyethoxy) silane. However, it is contemplated that a wide range of vinyl and acrylic monomers having trialkoxy silane functional groups or a moiety that reacts easily with water to form a silanol group, such as a chlorosilane or an acetoxysilane, provide the desired effects to PEO and are effective monomers for grafting in accordance with the copolymers of the present invention.

When reacting a polyethylene oxide with methacryloxypropyl trimethoxy silane to form a derivatized polyethylene oxide, the equation can be represented as follows:

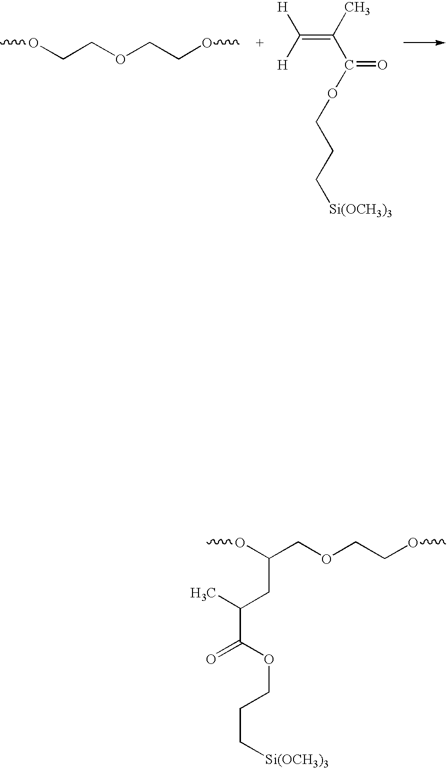

When treating sheets with a friction reduction compound containing a derivatized polyethylene oxide, the composition can be applied to the sheet topically or can be incorporated into the sheet by being premixed with the fibers that are used to form the web. When applied topically, the derivatized polyethylene oxide can be applied using any of the techniques described above with respect to topically applying a high molecular weight polyethylene oxide. If placed into a solution and applied to the sheet, it is believed that almost any liquid can be used as a solvent. For instance, the solvent can be an organic solvent, such as an alcohol, ketone, aldehyde, alkane, alkene, aromatic, or mixtures thereof. Alternatively, the solvent can be water. For example, many derivatized polyethylene oxides can be dissolved in water under high shear.

When the derivatized polyethylene oxide is applied to fibers prior to formation of the sheet, the derivatized polyethylene oxide can be formulated such that the composition forms a bond with the fibers during formation of the sheet. In particular, one or more monomers can be reacted with the polyethylene oxide during formation of the derivatized polyethylene oxide to provide charge or basis for a charge development within the polymer. The charge is typically cationic, but can also be anionic or amphoteric. The presence of a charge makes the material substantive to cellulose fibers when applied to the fibers in the wet end of the sheet making process.

For example, in one embodiment, the derivatized polyethylene oxide can be added to an aqueous suspension of fibers that are used to form a paper sheet. The derivatized polyethylene oxide can bond to the fibers and become incorporated into the sheet formed from the fibers. If the derivatized polyethylene oxide does not bond with the fibers, a substantial amount of the composition may be removed from the fibers when the aqueous suspension of fibers are formed into a web and drained.

In another embodiment, the friction reduction compound is an addition copolymer or polymer derived from ethylenically unsaturated monomers wherein at least one monomer comprises a pendant polyethylene oxide moiety. The method by which the polymers are made is not critical to the invention. The polymers may be made by any of the methods broadly known in the art for preparing addition polymers from ethylenically unsaturated monomers. The individual monomers making up the polymer may be arranged in a random or block pattern or a mixture of random and block patterns. The weight average molecular weight of the polymers can vary but specifically have a weight average molecular weight of about 20,000 or greater and, more specifically, about 50,000 or greater. The polyalkylene oxide moiety pendant group has a degree of polymerization greater than 2, more specifically greater than 3 and most specifically greater than about 5. That is, the pendant polyalkylene oxide group will contain 2 or more polyalkylene oxide units in the pendant chain.

Such compounds will have the general formula:
—{—[Q¹]ₐ—[Q²]_{b}—[Q³]_{c}—}_{w}—
wherein:
“a” and “b” are integers greater than or equal to 0;
“c” is an integer greater than 0;
“w” is an integer greater than or equal to 1;
Q¹ is a monomer unit, preferably non-anionic, containing a functionality capable of hydrogen or covalently bonding with cellulose or any other polar or non-polar monomer not containing a pendant polyalkylene oxide functionality;
Q² is a monomer unit containing a cationic charge functionality; and
Q³ is a monomer unit or mixture of monomer units containing pendant polyalkylene oxide functionality wherein said pendant polyalkylene oxide functionality has a degree of polymerization greater than about 2.

The ratio of “c” to “(a+b+c)” may vary such that the weight ratio of Q³ to [Q¹+Q²+Q³] is from about 5 to 100 percent, more specifically from about 10 to 100 percent and most specifically from about 20 to 100 percent.

In a specific embodiment the charge functionality Q² is cationic. Examples of suitable monomers for incorporating the charge functionality include, but are not limited to: [2-(methacryloyloxy)ethyl] trimethylammonium methosulfate (METAMS); dimethyldiallyl ammonium chloride (DMDAAC); 3-acryloamido-3-methyl butyl trimethyl ammonium chloride (AMBTAC); trimethylamino methacrylate; vinyl benzyl trimethyl ammonium chloride (VBTAC); 2-[(acryloyloxy)ethyl] trimethylammonium chloride; and [2-(methacryloyloxy)ethyl] trimethylammonium chloride.

In another embodiment, such compounds include cationic acrylamide copolymers with ethylenically unsaturated monomers having pendant ethylene oxide functionality. Such materials particularly have a weight average molecular weight of about 20,000 or greater, more specifically about 50,000 or greater. These compounds can be represented as follows: 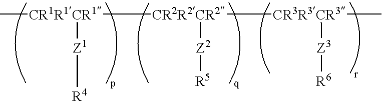
wherein R′, R″, R², R²′, R²″, R³, R³′, R³ are independently H, or C₁₋₄alkyl. Z¹, Z², Z³ are any bridging radicals, which can be the same or different, whose purpose is to incorporate the R¹ moieties into the ethylenically unsaturated polymer backbone. Suitable radicals include, but are not limited to, —CONH—, NHCO—, —O—, —S—, —CH₂—, -aryl-, —COO—, —OOC— and the like. R⁴ can be any functional group incorporated as part of an ethylenically unsaturated monomer. R⁵ is any cationically charged species. R⁶ is a polyoxyethylene or polyoxyalkylene derivative of the formula: —(CHR⁷CHR⁸O)ₙ—(CH₂CH₂O)ₜ—(CHR⁹CHR¹⁰O)ᵥ—R¹¹, wherein R⁷, R⁸, R⁹, R¹⁰ are independently C₁₋₄ alkyl groups; “s”, “t” and “v” are integers such that “t” is greater than 0 and “s+t+v” is greater than 3. R¹¹ can be any suitable terminating radical including H, alkyl, substituted alkyl, aryl and substituted aryl. Values of “p” and “q” are greater than or equal to 0 while the value of “r” is greater than 0. The percent of R⁶ in the polymer should range from about 5 to 100 weight percent, more specifically from about 10 to 100 weight percent and still more specifically from about 20 to 100 weight percent of the total polymer. In theory, any -[Q]^{j}-elements, which represent any ethylenically unsaturated monomer unit, can be built into the polymer without interfering with the perceived tactile properties as long as the R⁶ units are present in the polymer at the stated level.

The above addition polymers can be block copolymers or random copolymers. The compounds can be water-dispersible or water-soluble. Further, the compounds can be substantive to cellulose fibers and, therefore, can be applied topically to the sheet or can be applied to the fibers prior to formation of the sheet, such as by being incorporated into the wet end of a paper making process. For example, in one embodiment, when incorporated into an aqueous suspension of fibers during the formation of the sheet, the compound can be added in an amount from about 5 to about 10 pounds per ton of fibers. Depending upon the compound used, however, greater or lesser amounts may be added.

For topical applications, “p” and “q” in the formula above can be zero. For wet end applications, however, “p” can be zero but “q” is greater than zero. In the formula above, the upper limits of “p”, “q” and “r” are defined by the molecular weight of the polymer.

Particular acrylate copolymers containing polyethylene oxide moieties that can be used in this embodiment include 2-hydroxyethyl methacrylate copolymers and poly(ethylene glycol) alkyl ether methacrylate copolymers, such as poly(ethylene glycol) ethyl ether methacrylate copolymers or poly(ethylene glycol) methyl ether methacrylate copolymers.

In one embodiment, the friction reduction compound can include the following compound:

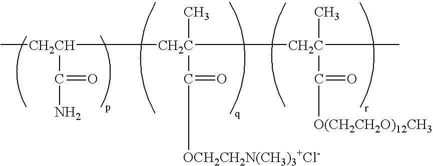

In one particular embodiment of the above polymer, “p”=0.8, “q”=0.1 and “r”=0.1. In this embodiment, the monomers can be incorporated in random fashions. Such a polymer can be made from commercially available monomers by standard polymerization techniques known to those skilled in the art.

The use of polymers containing anionic charges generally is discouraged due to the ability of calcium ions to react with the anionic charge on the polymer and render the polymer insoluble.

It should also be understood that a variety of other friction reducing compounds may be suitable for use within the present invention and that the present invention is not limited to the aforementioned compounds. Compounds and materials for reducing the coefficient of friction of solid materials when the materials are wetted with water are described in the art. Any of these materials may be satisfactory for use in the present invention provided they can be successfully incorporated into the sheet and that their incorporation is not antagonistic to the benefits described.

For purposes of this invention, the non-woven fibrous sheet can be any low density non-woven sheet useful as a wiping product and having a dry sheet bulk of 2 cubic centimeters or greater per gram, more specifically about 3 cubic centimeters or greater per gram, more specifically about 4 cubic centimeters or greater per gram, more specifically from about 4 to about 25 cubic centimeters per gram, and still more specifically from about 4 to about 18 cubic centimeters per gram. Excluded are relatively high density sheets commonly used as writing papers and the like. Particularly suitable non-woven fibrous sheets include cellulosic or paper sheets useful as facial tissues, bath tissues, paper towels, table napkins, wipes and the like. Other suitable non-woven fibrous sheets include those consisting essentially of synthetic fibers or comprising a blend of synthetic and natural fibers such as are commonly used for baby wipes and other wet wipe products. Suitable natural hydrophilic fibers include those prepared from polylactic acid.

Additional chemical additives may be applied to the sheets provided their use is not antagonistic to the desired results. It is necessary to avoid a reaction that would cause precipitation of one or more components of the deliquescent material that would render the material no longer being deliquescent. For example, with calcium chloride, the interaction with sodium carbonate would cause precipitation of calcium carbonate with formation of the non-deliquescent compound sodium chloride. Hence, the resulting sheet would no longer be capable of a high equilibrium moisture content. Additional chemical additives of particular interest are temporary and permanent wet strength agents.

The temporary wet strength agents may be cationic, nonionic or anionic. Such compounds are well known in the papermaking arts and include PAREZ™ 631 NC and PAREZ® 725 temporary wet strength resins, which are cationic glyoxylated polyacrylamides available from Cytec Industries (West Paterson, N.J.). Hercobond 1366, manufactured by Hercules, Inc., located at Wilmington, Del., is another commercially available cationic glyoxylated polyacrylamide that may be used in accordance with the present invention. Additional examples of temporary wet strength agents include dialdehyde starches and polysaccharides such as Cobond® 1000 from National Starch and Chemcial Company and other aldehyde containing polymers.

Permanent wet strength agents comprising cationic oligomeric or polymeric resins can be used in the present invention. Polyamide-polyamine-epichlorohydrin type resins such as KYMENE 557H sold by Hercules, Inc., located at Wilmington, Del., are the most widely used permanent wet-strength agents and are suitable for use in the present invention. Other cationic resins include polyethylenimine resins and aminoplast resins obtained by reaction of formaldehyde with melamine or urea. It is often advantageous to use both permanent and temporary wet strength resins in the manufacture of tissue products with such use being recognized as falling within the scope of the present invention.

The products of the present invention may also include the incorporation of dry strength agents in the tissue. Such dry strength agents may be applied to the tissue sheet without affecting the ability of the compounds to reduce the coefficient of friction of the sheet when used in conjunction with the deliquescent materials. Such dry strength agents are well known in the art and include, but are not limited to, modified starches and other polysaccharides such as cationic, amphoteric, and anionic starches and guar and locust bean gums, modified polyacrylamides, carboxymethylcellulose, sugars, polyvinyl alcohol, chitosans, and the like. Such dry strength agents are typically added to the fiber slurry prior to tissue sheet formation or are added during creping.

The tensile strengths of the products of the invention may vary considerably depending upon the particular application for which the product is employed. Typically the products of the present invention will have geometric mean tensile strengths of about 100 grams or greater per inch of sample width (g/inch), more specifically about 150 grams or greater per inch of sample width, more specifically from about 100 to about 2000 g/inch, and still more specifically from about 150 to about 1500 g/inch.

Softening agents, sometimes referred to as debonders, can be used to enhance the softness of the tissue product and such softening agents can be incorporated with the fibers before, during or after formation of the aqueous suspension of fibers. Such agents can also be sprayed or printed onto the web after formation, while wet or dry. Suitable agents include, without limitation, fatty acids, waxes, quaternary ammonium salts, dimethyl dihydrogenated tallow ammonium chloride, quaternary ammonium methyl sulfate, carboxylated polyethylene, cocamide diethanol amine, coco betaine, sodium lauryl sarcosinate, partly ethoxylated quaternary ammonium salt, distearyl dimethyl ammonium chloride, polysiloxanes and the like. Examples of suitable commercially available chemical softening agents include, without limitation, Berocell 596 and 584 (quaternary ammonium compounds) manufactured by Eka Nobel Inc., Adogen 442 (dimethyl dihydrogenated tallow ammonium chloride) manufactured by Sherex Chemical Company, Quasoft 203 (quaternary ammonium salt) manufactured by Quaker Chemical Company, and Arquad 2HT-75 (di(hydrogenated tallow) dimethyl ammonium chloride) manufactured by Akzo Chemical Company. Suitable amounts of softening agents will vary greatly with the species selected and the desired results. Such amounts can be, without limitation, from about 0.05 to about 1 weight percent based on the weight of fiber, more specifically from about 0.25 to about 0.75 weight percent, and still more specifically from about 0.4 to about 0.6 weight percent.

Additional softeners may be applied topically to enhance the surface feel of the product. An especially suitable topical softener for this application is polysiloxane. The use of polysiloxanes to soften tissue sheets is broadly taught in the art. A large variety of polysiloxanes are available that are capable of enhancing the tactile properties of the finished tissue sheet. Any polysiloxane capable of enhancing the tactile softness of the tissue sheet is suitable for incorporation. Examples of suitable polysiloxanes include, but are not limited to, linear polydialkyl polysiloxanes such as the DC-200 fluid series available from Dow Corning, Inc., Midland, Mich. as well as the organofunctional polydimethyl siloxanes such as the amino functional polydimethyl siloxanes. Examples of suitable polysiloxanes include those described in U.S. Pat. No. 6,054,020 issued on Apr. 25, 2000 to Goulet et al. and U.S. Pat. No. 6,432,270 issued on Aug. 13, 2002 to Liu et al., the disclosures of which are herein incorporated by reference to the extent that they are non-contradictory herewith. Additional exemplary aminofunctional polysiloxanes are the Wetsoft CTW family manufactured and sold by Wacker Chemie, Munich, Germany.

Additional types of chemicals may also be incorporated into the sheef provided they are not antagonistic to the benefits provided by the friction reduction compound and the deliquescent salts. Such chemicals include, but are not limited to, absorbency aids usually in the form of cationic, anionic, or non-ionic surfactants, humectants and plasticizers such as low molecular weight polyethylene glycols and polyhydroxy compounds such as glycerin and propylene glycol.

In the interests of brevity and conciseness, any ranges of values set forth in this specification contemplate all values within the range and are to be construed as written description support for claims reciting any sub-ranges having endpoints which are whole number values within the specified range in question. By way of a hypothetical illustrative example, a disclosure in this specification of a range of from 1 to 5 shall be considered to support claims to any of the following ranges: 1-5; 14; 1-3; 1-2; 2-5; 24; 2-3; 3-5; 3-4; and 4-5. In addition, any of the foregoing aspects of this invention can be further defined by any combination of one or more of the specified values and ranges recited for any properties described herein.

### Test Methods

As used herein, the “dry sheet bulk” is calculated as the quotient of the “dry sheet caliper” (hereinafter defined) of a sheet, expressed in microns, divided by the dry basis weight, expressed in grams per square meter. The resulting dry sheet bulk is expressed in cubic centimeters per gram. More specifically, the dry sheet caliper is the representative thickness of a single sheet measured in accordance with TAPPI test methods T402 “Standard Conditioning and Testing Atmosphere For Paper, Board, Pulp Handsheets and Related Products” and T411 om-89 “Thickness (caliper) of Paper, Paperboard, and Combined Board” with Note 3 for stacked sheets. The micrometer used for carrying out T411 om-89 is an Emveco 200-A Tissue Caliper Tester available from Emveco, Inc., Newberg, Oreg. The micrometer has a load of 2 kilo-Pascals, a pressure foot area of 2500 square millimeters, a pressure foot diameter of 56.42 millimeters, a dwell time of 3 seconds and a lowering rate of 0.8 millimeters per second.

As used herein, the “equilibrium moisture content” represents the moisture content of the fibrous sheet at 50% relative humidity and 25° C. (standard TAPPI conditions). At equilibrium, the amount of moisture within the sheet will not change with time at the same humidity condition. The equilibrium moisture content is expressed as a weight percent of the dry sheet including the deliquescent material and any additional non-volatile components. For dry wiping products, the dry sample sheets should be conditioned at least 4 hours at the TAPPI standard conditions prior to determining the equilibrium moisture content of the sheet. For wet wiping products, the wet sample sheets should first be dried at 100° C. for a minimum of 1 hour. The dried sample should then be conditioned at least 4 hours at TAPPI standard conditions prior to determining the equilibrium moisture content of the sheet.

After conditioning, sample tissue sheets are cut to a suitable size. Actual dimensions of the sheet are not critical as long as the sheets fit within the drying oven and can be easily weighed. It is recommended to use enough sample so that the equilibrium sample weight is from about 2 to about 10 grams. The conditioned samples are placed into a suitable pre-weighed dry container having a lid, wherein the weight of the container and lid, “W_{c}”, has been recorded to the nearest 0.01 gram. After the conditioned samples are placed in the container, the container, sample and lid are weighed to the nearest 0.01 gram. The sample, container and lid weight, “Wₜ”, is recorded to the nearest 0.01 gram. The equilibrium sample weight, “Wₑ”, is then determined by weight difference (Wₑ=Wₜ-W_{c}). After removing the lid, the uncapped container, lid and sample are then placed in a 105° C. oven and dried for at least 15 minutes. The container is then capped to prevent moisture absorption and the container, sample and lid are cooled in a desiccator. The weight of the container, lid and dried sample, “W_{td}”, is recorded. The dried sample weight, “W_{d}”, is then calculated by subtracting the weight of the container and lid weight from the combined weight of the container and sample (W_{d}=W_{td}−W_{c}). The equilibrium moisture content, “Eₘ”, expressed as percent, is then calculated from the following equation: Eₘ=(Wₑ−W_{d})/W_{d}*100%.

Tensile strengths for tissue products intended for use as dry tissue products should be measured according to TAPPI Test Method T 494 om-88 for tissue. Suitable instruments for include the MTS SINTECH.RTM.1/G tensile tester (or equivalent). Sample widths of 1 inch or 3 inches and jaw spans of 2 inches or 4 inches may be used depending upon the particular substrate being tested. A crosshead speed of 10 inches per minute is used. The sample is conditioned under TAPPI conditions (50% RH, 22.7.degree. C.) before testing. Ten samples are tested in both the machine direction (MD) and cross-machine direction (CD) directions and the average of the ten samples is used to calculate the geometric mean tensile strength (GMT), expressed in grams per inch. The geometric mean tensile strength is the square root of the product of the machine direction tensile strength and the cross-machine direction tensile strength. When using sample widths different from 1 inch, the tensile strength should be converted into units of grams/inch by dividing the result by the sample width.

Tensile testing for wet wipes products is similar to that for dry products. Although all tests are done under TAPPI standard test conditions, the wet wipes are not equilibrated to those conditions. Instead, the wipes are removed from a sealed container or cartridge and tested within a few minutes, generally less than 5-10 minutes, after opening the container or cartridge. This is about a 5 minute variation in the time period that the wet wipe is exposed to the atmosphere, which does not materially or significantly alter the test results.

Tensile values are obtained on the wet wipes products following ASTM 1117-80, section 7, or equivalent, with the following modifications: sample dimensions are 1±0.04 inch (25.4±1.0 mm) wide and 4.25±0.04 inches (108.0±1.0 mm) long; initial gauge length is 3±0.04 inches (76.2±1.0 mm); and the test speed is 12 inches/minute (305.0 mm/min). Ten specimens are tested in both the machine and cross-machine directions for each product and the average tensile strength in each direction is determined. From those values, the geometric mean tensile strength is determined. The test can be carried out on a standard tensile tester such as an MTS Sintech 1/G test machine with TestWorks 3.10 software. Both the Sintech test machine and the TestWorks software are available from MTS Corporation located at 1400 Technology Drive, Eden Prairie, Minn.

The “coefficient of friction” (COF) can be determined by using a TMI Slip & Friction tester available from Testing Machines Inc., Ronkonkoma, N.Y. Samples are conditioned at 23° C.±1° C. and 50%±2% relative humidity for a minimum of 4 hours prior to testing. The sample sheets are cut to a 6.35 cm width and sufficient length to be clamped in the sled. The sample is then placed and secured in the test sled. If sufficient strength is lacking in the sheet such that the sheet rips or shreds during analysis, the sheet is backed with clear acrylic tape to prevent disintegration of the sheet. COF units are reported in grams. Specific test parameters are as follows: delay—5 seconds; sled—200 grams, 6.35×6.35 cm; static duration—2000 ms; static speed—1 cm/min; kinetic speed—15.25 cm/min; kinetic length—20.5 cm.

### EXAMPLES

Five comparative tissue samples were prepared by spraying the two outer surfaces of a conventional 2-ply facial tissue with different materials and then drying the treated product in an oven for 15 minutes at 105° C. After drying, the samples were allowed to equilibrate for 16 hours at 23° C.±1° C. and 50% i 2% relative humidity.

In particular, Sample “A” (comparative) was prepared by spraying the tissue with a 2 percent aqueous solution of a cationic polyacrylamide of the following structure: 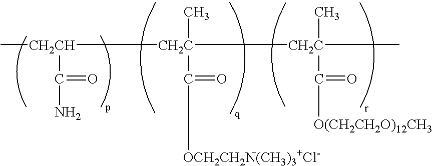
wherein p=0.8, q=0.1 and r=0.1. The monomers were incorporated into the polymer in random fashion. The add-on amount of the solution was approximately 50 percent by weight of the dry fibers, resulting in a polymer add-on amount of approximately 1 percent by weight of fiber.

Sample “B” (this invention) was prepared by further spraying the Sample “A” tissue with a 10% solution of lithium chloride with an add-on amount of about 50% by weight of dry fiber, resulting in a total lithium chloride add-on amount of about 5% by weight of dry fibers.

Sample “C” (comparative) was prepared by spraying the tissue with distilled water with an add-on amount of about 50% by weight of dry fiber.

Sample “D” (comparative) was prepared by spraying the tissue with a 10% solution of lithium chloride with an add-on amount of about 50% by weight of dry fiber, resulting in a total lithium chloride concentration of about 5% by weight of dry fibers.

Sample “E” (this invention) was prepared by spraying the tissue with an aqueous solution containing 20% by weight of calcium chloride and 5% by weight of PolyOX® WSR-N10 high molecular weight polyethylene oxide available from Dow Chemical. The solution was added at an amount of about 50% by weight of dry fiber, resulting in a total calcium chloride concentration of about 10% by weight of dry fibers.

The five different samples were then analyzed for a qualitative comparison of their tactile properties. The results are summarized below:
Sample A—Rough to the touch. Somewhat stiff.
Sample B—Smooth and drapeable. Slick, smooth surface feel.
Sample C—Rough to the touch, but not as rough or as stiff as Sample A.
Sample D—Drapeable. Better feel than either of Samples A or C, but noticeably less slick feel than Sample B.
Sample E—Smooth and drapeable. Slick, smooth surface feel similar to B.

Noticeably more slick than sample D.

These results illustrate the improved feel of the products of this invention.

It will be appreciated that the foregoing description and examples, given for purposes of illustration, are not to be construed as limiting the scope of this invention, which is defined by the following claims and all equivalents thereto.

1. A wiping product comprising a non-woven fibrous sheet containing a deliquescent material and a friction reduction compound.

2. The wiping product of claim 1 wherein the friction reduction compound is selected from the group consisting of high molecular weight polyethylene oxide, derivatized polyethylene oxide, addition copolymers having a pendant ethylene oxide moiety, and mixtures thereof.

3. The product of claim 1 wherein the non-woven fibrous sheet comprises cellulose papermaking fibers, synthetic fibers, or a mixture thereof.

4. The product of claim 1 wherein the fibers of the non-woven fibrous sheet consist essentially of cellulose papermaking fibers.

5. The product of claim 1 wherein the amount of the deliquescent material in the sheet is from about 1 to about 150 weight percent based on dry fiber.

6. The product of claim 1 wherein the equilibrium moisture content of the sheet Is about 8 weight percent or greater.

7. The product of claim 1 wherein the equilibrium moisture content of the sheet is about 10 weight percent or greater.

8. The product of claim 1 wherein the equilibrium moisture content of the sheet is from about 8 to about 200 weight percent.

9. The product of claim 1 wherein the equilibrium moisture content of the sheet is from about 10 to about 100 weight percent.

10. The product of claim 1 wherein the equilibrium moisture content of the sheet is from about 10 to about 50 weight percent.

11. The product of claim 1 wherein the equilibrium moisture content of the sheet is from about 10 to about 30 weight percent.

12. The product of claim 1 wherein the deliquescent material is a salt selected from the group consisting of aluminates, calcium chloride, lithium chloride, magnesium chloride, sodium acetate, potassium acetate, ammonium acetate and trimethylamine n-oxide.

13. The product of claim 1 wherein the deliquescent material is selected from the group consisting of lithium chloride, calcium chloride, magnesium chloride and mixtures thereof.

14. The product of claim 1 wherein the friction reduction compound is polyethylene oxide having a weight average molecular weight of about 20,000 or greater.

15. The product of claim 1 wherein the friction reduction compound is a derivatized polyethylene oxide.

16. The product of claim 1 wherein the friction reduction compound is an addition copolymer having a pendant ethylene oxide moiety.

17. The product of claim 1 wherein the amount of the friction reduction compound is about 0.001 dry weight percent or greater.

18. The product of claim 1 wherein the amount of the friction reduction compound is from about 0.005 to about 10 dry weight percent.

19. The product of claim 1 wherein the amount of the friction reduction compound is from about 0.01 to about 5 dry weight percent.

20. The product of claim 1 wherein the amount of the friction reduction compound is from about 0.01 to about 1 dry weight percent.

21. The product of claim 1 selected from the group consisting of facial tissue, bath tissue and paper towel.

22. The product of claim 1 wherein said product is a wet wipe.

23. The product of claim 1 further comprising a permanent or temporary wet strength agent.
